(19) United States
(12) Patent Application Publication
(10) Pub. No.: US 2023/0213362 A1
(43) Pub. Date: Jul. 6, 2023

(54) BRAGG GRATING EROSION SENSOR FOR HARSH ENVIRONMENT

(71) Applicant: COMMISSARIAT A L'ENERGIE ATOMIQUE ET AUX ENERGIES ALTERNATIVES, Paris (FR)

(72) Inventors: Romain COTILLARD, Bazoches Sur Guyonne (FR); Guillaume LAFFONT, Gif-Sur-Yvette Cedex (FR); Nicolas ROUSSEL, Paris (FR)

(73) Assignee: COMMISSARIAT A L'ENERGIE ATOMIQUE ET AUX ENERGIES ALTERNATIVES, Paris (FR)

(21) Appl. No.: 18/000,657

(22) PCT Filed: Jun. 1, 2021
(86) PCT No.: PCT/FR2021/050991

§ 371 Date: Dec. 2, 2022

(30) Foreign Application Priority Data
Jun. 5, 2020 (FR) FR2005913

(51) Int. Cl. G01D 5/353

(52) U.S. Cl. CPC G01D 5/35316

(57) ABSTRACT

An erosion sensor includes one or more optical fibres each having one or more cores and an optical sheath surrounding the one or more cores, a variable pitch measurement Bragg grating inscribed in one of the cores of one of the optical fibres over a measurement section to be eroded, and one or more reference Bragg gratings each inscribed in one of the cores. The reference Bragg grating is used to correct the physical length of the measurement section determined from the width of the spectrum reflected by the measurement Bragg grating, taking into account the thermomechanical parameters imposed on the erosion sensor.

### TECHNICAL FIELD

The invention belongs to the field of optical fibre sensors and, more specifically, to the field of optical fibre Bragg grating sensors. It relates to an erosion sensor comprising a variable pitch Bragg grating inscribed on a measurement section to be eroded.

The invention finds particular application in the field of predictive maintenance, for monitoring the wear of parts by means of integrated sensors. It is of particular interest when optical fibre sensors are subjected to harsh environments, for example high temperatures and/or ionising radiation irreversibly modifying the optical properties of the optical fibre. The invention is also particularly useful when the optical fibre sensors are subjected to significant thermomechanical variations, causing the sensitivity of the sensor to vary significantly.

### PRIOR ART

Variable pitch fibre Bragg gratings, called “chirped fibre Bragg gratings”, are optical components that create a direct, potentially linear relationship between their physical dimension and the spectral width of the radiation reflected by these Bragg gratings. Bragg gratings can thus be used as erosion sensors, the physical length of a grating being determined from the measurement of the spectral width of the reflected radiation. In harsh environments, the optical fibre and the Bragg grating inscribed in this fibre undergo accelerated ageing leading to a modification of their optical properties. Ageing can in particular be accelerated by exposure to high temperatures and ionising radiation. Moreover, the spectral response of variable pitch Bragg gratings is also influenced by the temperature, pressure and deformation conditions to which the Bragg gratings are subjected. As long as these conditions remain relatively stable and close to the calibration conditions, the reflected radiation remains mainly influenced by the decrease in the length of the variable pitch Bragg grating. On the other hand, when a variable pitch fibre Bragg grating is subjected to significant variations in temperature, pressure and/or deformation, the spectrum of the radiation reflected by the Bragg grating undergoes both a frequency shift and a change in its width. Consequently, the ageing of the fibre and the variations of the physical parameters to which the variable pitch Bragg grating is subjected distort the measurement of the physical length of the variable pitch Bragg grating.

Consequently, although certain optical fibres incorporating Bragg gratings are suitable for use as sensors in extreme environments, in particular because of their mechanical strength, their measurement precision is altered in these environments.

An object of the invention is therefore to propose a solution for reliably measuring the physical length of a fibre variable pitch Bragg grating despite its ageing and variations in the parameters of its environment. The invention also aims at providing an erosion sensor whose design, manufacture and maintenance costs are compatible with a use on an industrial scale.

### DESCRIPTION OF THE INVENTION

To this end, the invention is based on taking into account the environment of the variable pitch Bragg grating, called measurement Bragg grating, by measuring the radiation reflected by another Bragg grating, called reference Bragg grating, inscribed in the same optical fibre or in a neighbouring optical fibre, and therefore subjected to physical parameters identical or similar to those to which the variable pitch Bragg grating is subjected.

More specifically, the object of the invention is a Bragg grating erosion sensor comprising:
one or more optical fibres, each optical fibre comprising one or more cores and an optical sheath surrounding the one or more cores,
a variable pitch measurement Bragg grating inscribed in one of the cores of one of the optical fibres over a measurement section to be eroded, and
one or more reference Bragg gratings, each reference Bragg grating being inscribed in one of the cores of one of the optical fibres.

For given temperature, pressure and deformation conditions, and for a given physical length of the measurement Bragg grating, said measurement Bragg grating is arranged to reflect radiation in a range of wavelengths called the “measurement range”. When the measurement Bragg grating has not undergone erosion, the measurement range is called “initial measurement range”. For the same temperature, pressure and deformation conditions, the width of the measurement range decreases with the erosion of the measurement section. Moreover, each reference Bragg grating is arranged to reflect radiation in a range of wavelengths called the “reference range”. In the presence of several reference Bragg gratings, the various reference ranges may be identical, separate, or partially overlap. In the present description, any comparison between two wavelength ranges implies that the Bragg gratings considered are subjected to the same or similar temperature, pressure and deformation conditions.

When the erosion sensor includes several optical fibres, the optical fibres are preferably arranged relative to each other in order to be subjected to the same temperature and pressure conditions. The optical fibres can in particular be mechanically connected to each other. In particular, they can be mechanically connected over a section encompassing both the measurement Bragg grating and the one or more reference Bragg gratings. Thus, the one or more reference Bragg gratings are subjected to the same deformations as the measurement Bragg grating.

According to a particular embodiment, at least one of the one or more reference Bragg gratings is a constant pitch Bragg grating. Such a Bragg grating is formed of patterns spaced from each other by the same distance along the longitudinal axis of the optical fibre. It reflects incident radiation at a wavelength called the “Bragg wavelength” or “reference wavelength”. In practice, radiation can be reflected over a wavelength range of a few nanometres.

The measurement Bragg grating and at least one of the one or more reference Bragg gratings can be inscribed in the same core of an optical fibre. Each reference Bragg grating can be inscribed in the measurement section or outside this measurement section. Preferably, each reference Bragg grating is arranged to reflect radiation in a reference range separate from the measurement range. Thus, the spectra of the radiation reflected by the various Bragg gratings can be distinguished from each other.

Still according to a particular embodiment, at least one Bragg grating is formed by a set of bubbles. The measurement Bragg grating and/or one or more of the reference Bragg gratings can be Bragg gratings each formed by a set of bubbles. Such a Bragg grating corresponds to a type III point-to-point grating inscribed by femtosecond laser pulses. Each bubble has a shape approaching a sphere, the diameter of which may be less than or equal to 1 urn. In any event, each bubble has a maximum dimension (diameter) less than or equal to the diameter of the core of the optical fibre wherein the patterns are inscribed. The same core can thus accommodate a plurality of Bragg gratings on the same section. In this case, the core of an optical fibre can accommodate the measurement Bragg grating and one or more reference Bragg gratings on the same section.

According to yet another particular embodiment, one of the one or more optical fibres comprises a measurement core and a reference core. The measurement Bragg grating can then be inscribed in the measurement core and at least one of the one or more reference Bragg gratings can be inscribed in the reference core.

According to this last particular embodiment, each reference Bragg grating inscribed in the reference core can be arranged to reflect radiation in a wavelength range (reference range) comprised in a range of wavelengths reflected by the measurement Bragg grating (measurement range).

The measurement section can extend between a proximal end, arranged to receive incident radiation, and a distal end, arranged to be eroded. The one or more reference Bragg gratings can then comprise a first reference Bragg grating inscribed on a first reference section located in the vicinity of the proximal end. The first reference Bragg grating is then located at a distance from the end to be eroded and can provide a reference measurement throughout the erosion of the measurement Bragg grating, or practically throughout this erosion.

According to a first embodiment, the first reference section is located upstream of the measurement section, that is to say on a section of optical fibre normally not to be eroded.

According to a second embodiment, the first reference section is included in the measurement section. The first reference Bragg grating is then liable to be eroded with the measurement Bragg grating. However, the first reference Bragg grating generally has a relatively small physical length compared to the physical length of the measurement Bragg grating. This length may be less than the minimum safety length of the measurement section, for which the erosion sensor must be replaced. By way of example, the first reference Bragg grating may have a physical length of 1 mm and the measurement Bragg grating may have a physical length comprised between a few millimetres and a few centimetres or decimetres.

According to a particular embodiment, the one or more reference Bragg gratings comprise a plurality of second reference Bragg gratings distributed along the measurement section. These second reference Bragg gratings allow to measure a variation of a physical parameter along the measurement section.

Preferably, the second Bragg gratings are arranged to reflect radiation in wavelength ranges (reference ranges) distinct from each other. Still preferably, the second Bragg gratings are arranged to reflect radiation in wavelength ranges (reference ranges) that are separate from each other.

According to this last particular embodiment, one of the one or more optical fibres can comprise a measurement core and a reference core. The measurement Bragg grating can then be inscribed in the measurement core and the second reference Bragg gratings can be inscribed in the reference core. Advantageously, each second reference Bragg grating has a pitch equal to a local pitch of the measurement Bragg grating.

The erosion sensor according to the invention may further comprise a processing unit arranged to measure a spectral width of radiation reflected by the measurement Bragg grating, to measure a wavelength of radiation reflected by at least one reference Bragg grating, and determine a physical length of the measurement section according to the spectral width of the radiation reflected by the measurement Bragg grating and the wavelength of the radiation reflected by the at least one reference Bragg grating. Thus, the determination of the physical length of the measurement section from the spectral width of the radiation reflected by the measurement Bragg grating is corrected from the effects of the other parameters influencing the spectral response of the measurement Bragg grating.

The processing unit can be arranged to determine the physical length of the measurement section according to the spectral width of the radiation reflected by the measurement Bragg grating and to a wavelength difference between a wavelength of the radiation reflected by the measurement Bragg grating and the wavelength of the radiation reflected by the at least one reference Bragg grating. In particular, the wavelength considered for the radiation reflected by the measurement Bragg grating can be the lower limit, the upper limit, or an average value of the range of wavelengths wherein the measurement Bragg grating reflects radiation (measurement range). This is for example the terminal closest to the wavelength of the radiation reflected by the at least one reference Bragg grating.

Furthermore, the processing unit can be arranged to measure a wavelength of the radiation reflected by each of the second reference Bragg gratings, to determine a variation of a physical parameter along the measurement section according to the wavelengths of the radiation reflected by the second reference Bragg gratings, and to determine the physical length of the measurement section according to the spectral width of the radiation reflected by the measurement Bragg grating and the variation of the physical parameter along the measurement section. The physical parameter likely to vary along the measurement section can be a temperature, a pressure or a deformation within an optical fibre.

The invention also relates to a method implementing the erosion sensor as described above. More specifically, the object of the invention is a method for determining the physical length of the measurement section of the erosion sensor as described above, comprising the steps of:
measuring a spectral width of radiation reflected by the measurement Bragg grating,
measuring a wavelength of radiation reflected by at least one reference Bragg grating, and
determining a physical length of the measurement section according to the spectral width of the radiation reflected by the measurement Bragg grating and the wavelength of the radiation reflected by the at least one reference Bragg grating.

### BRIEF DESCRIPTION OF THE DRAWINGS

Other features, details and advantages of the invention will become apparent upon reading the following description, given only by way of example and referring to the appended drawings wherein:

FIG. 1A schematically shows an example of a variable pitch Bragg grating inscribed in the core of an optical fibre;

FIG. 1B shows, by a graph, the variation of the pitch of the Bragg grating of FIG. 1A along the longitudinal axis of the optical fibre;

FIG. 1C shows, by a graph, the spectral response in reflection of the variable pitch Bragg grating of FIG. 1A;

FIG. 2A schematically shows the variable pitch Bragg grating of FIG. 1A after erosion;

FIG. 2B shows, by a graph similar to that of FIG. 1C, the spectral response in reflection of the variable pitch Bragg grating of FIG. 2A;

FIG. 3A schematically shows a variable pitch Bragg grating as a set of constant pitch Bragg gratings;

FIG. 3B shows the sensitivity of each constant pitch Bragg grating in FIG. 3A, according to the variation of a physical parameter;

FIG. 3C shows, by two graphs, the spectral response in reflection of each constant pitch Bragg grating of FIG. 3A, for two different physical states;

FIG. 4 shows, by a graph, an example of evolution of the width of the range of wavelengths of radiation reflected by a variable pitch Bragg grating during a temperature ramp varying between 750° C. and 20° C.;

FIG. 5A schematically shows a first exemplary embodiment of a Bragg grating erosion sensor according to the invention, comprising a single reference Bragg grating;

FIG. 5B shows, by a graph, the variation of the pitch of the measurement Bragg grating and of the reference Bragg grating of the erosion sensor of FIG. 5A, along the longitudinal axis of the optical fibre;

FIG. 5C shows, by a graph, the spectral response in reflection of the erosion sensor of FIG. 5A;

FIG. 6 shows, by a graph, the spectral response in reflection of the erosion sensor of FIG. 5A, for two different physical states;

FIG. 7 shows, by a graph, the spectral response in reflection of an example of an erosion sensor produced in accordance with the invention;

FIG. 8 shows, by a graph, the error in the determination of the physical length of the Bragg grating for measuring the erosion sensor of FIG. 7, with and without compensation for the variation of sensitivity of the measurement Bragg grating;

FIG. 9A schematically shows a second exemplary embodiment of a Bragg grating erosion sensor according to the invention, comprising a plurality of reference Bragg gratings inscribed in the same core as the measurement Bragg grating;

FIG. 9B shows, by a graph, the spectral response in reflection of the erosion sensor of FIG. 9A;

FIG. 10A schematically shows a third exemplary embodiment of a Bragg grating erosion sensor according to the invention, comprising a measurement Bragg grating inscribed in a first core of a multicore optical fibre and a plurality of reference Bragg gratings inscribed in a second optical fibre core;

FIG. 10B shows, by a graph, the spectral response in reflection of the erosion sensor of FIG. 10A;

FIG. 11A schematically shows a fourth exemplary embodiment of a Bragg grating erosion sensor according to the invention, comprising a first optical fibre wherein is inscribed a measurement Bragg grating and a second fibre wherein is inscribed a plurality of reference Bragg gratings;

FIG. 11B shows, by a graph, the spectral response in reflection of the erosion sensor of FIG. 11A;

FIG. 12 shows an example of a method for determining the physical length of a measurement Bragg grating in an erosion sensor according to the invention.

### DETAILED DESCRIPTION OF PARTICULAR EMBODIMENTS

A Bragg grating is a periodic or pseudo-periodic modulation of the refractive index in a waveguide, for example in the core of an optical fibre. For a period having a pitch Λ and an effective refractive index nₑ, a Bragg grating reflects radiation at the Bragg wavelength: λ_{Bragg}=2.κ.nₑ. Bragg gratings are sensitive to physical parameters such as temperature, mechanical deformations and hydrostatic pressure. This sensitivity results in a Bragg wavelength shift Δλ_{Bragg} defined by the equation:

$$\frac{Δ {λ}_{Bragg}}{{λ}_{Bragg}} = ( 1 + {p}_{e} ) Δ ε + ( α + ζ ) Δ T + c . Δ P$$

where Pₑ is the photoelastic constant, Δε the mechanical deformation, a the thermal expansion coefficient, ζ the thermo-optical coefficient, ΔT the temperature variation, c the pressure sensitivity and ΔP the pressure variation. The sensitivity of a Bragg grating to the physical parameters imposed on the optical fibre and the Bragg grating allows its use as a sensor.

A variable pitch Bragg grating, called “chirped fibre Bragg grating”, is a Bragg grating whose pitch is not constant but varies along the longitudinal axis of the optical fibre. The pitch variation can in particular be linear. Typically, the spectral response of a variable pitch Bragg grating is characterised by a spectral band in reflection whose width depends on the variation of the grating pitches, between the smallest pitch and the largest pitch. Thus, it is possible to determine the physical length of a variable pitch Bragg grating by measuring the width of the spectral band in reflection. In the case of a grating whose pitch varies linearly, any reduction in its physical length leads to a proportional reduction in the width of its spectral band in reflection. Bragg gratings with variable pitch can thus be used as an erosion sensor, for example to measure the level of wear of a part.

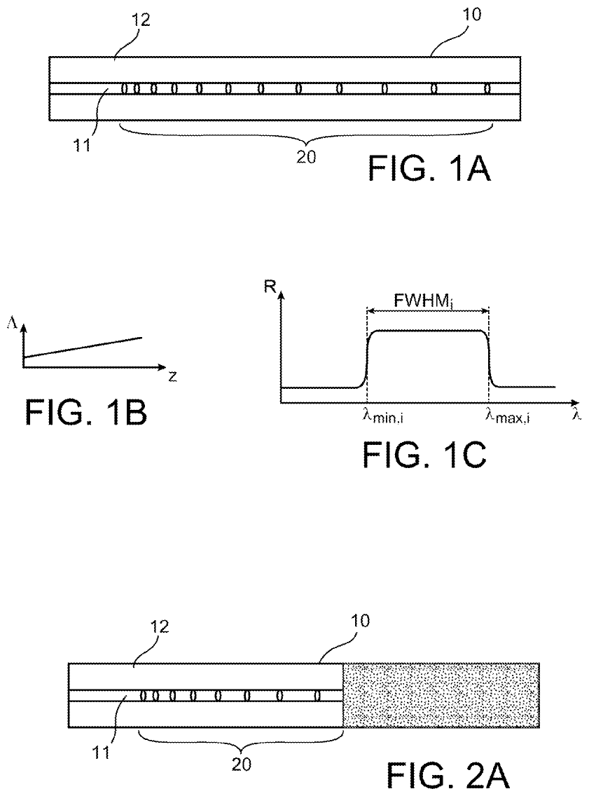

FIG. 1A schematically shows an example of a variable pitch Bragg grating inscribed in the core of an optical fibre. The optical fibre 10 includes a core 11 surrounded by an optical sheath 12. A variable pitch Bragg grating 20 is inscribed in the core 11 of the optical fibre 10 on a section called the “measurement section”. The patterns, or fringes, of the Bragg grating 20 are spaced from each other with a pitch Λ(z) varying linearly along the longitudinal axis of the optical fibre 10. The variation of the pitch Λ(z) along the longitudinal axis of the optical fibre 10 is also represented in FIG. 1B by a graph. The abscissa axis corresponds to the longitudinal position z of the patterns and the ordinate axis corresponds to the pitch Λ(z) between two successive patterns at the considered longitudinal position. FIG. 1C shows, by a second graph, the spectral response in reflection of the variable pitch Bragg grating 20 before erosion. The abscissa axis corresponds to the wavelength of the radiation reflected by the Bragg grating 20 and the ordinate axis corresponds to the amplitude R of the reflected radiation. The variable pitch Bragg grating 20 is arranged to reflect radiation over a range of wavelengths called the “initial measurement range”. This initial measurement range has an initial width at mid-height FWHMᵢ comprised between a minimum wavelength and a maximum wavelength λ_{max,i}.

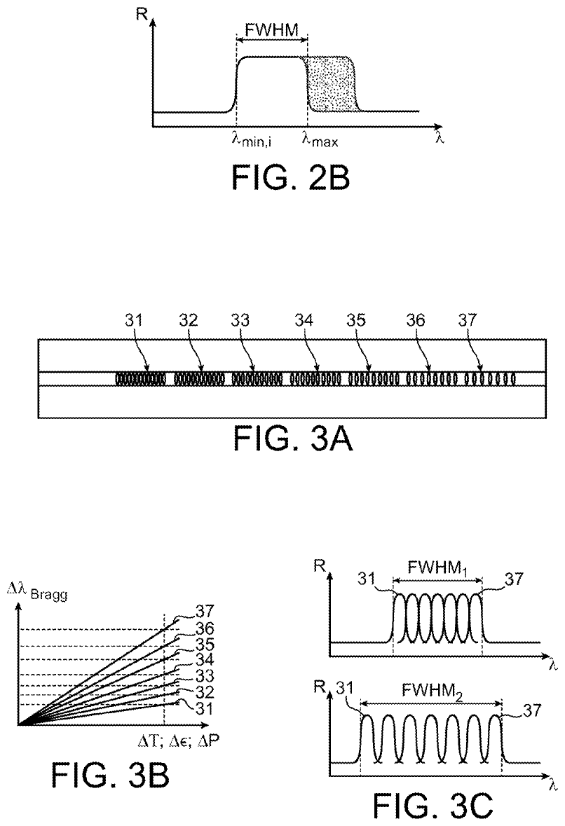

FIG. 2A schematically shows the variable pitch Bragg grating 20 of FIG. 1A after erosion. FIG. 2B shows, by a graph similar to that of FIG. 1C, the spectral response in reflection of the Bragg grating 20. The optical fibre 10 and the Bragg grating 20 have undergone erosion over a portion of the measurement section. This erosion results in a reduction in the physical length of the measurement section and generates a shift in the maximum wavelength Δₘₐₓ reflected by the Bragg grating 20. The width at mid-height FWHM of the measurement range is then reduced relative to the initial width at mid-height FWHMᵢ.

Determining the width of the measurement range of a variable pitch Bragg grating therefore allows to deduce its physical length. Nevertheless, like any other Bragg grating, a variable pitch Bragg grating is also sensitive to temperature, deformation and hydrostatic pressure. Due to chromatic dispersion, the variation of a physical parameter does not generate an identical wavelength shift for all the wavelengths of the measurement range. Thus, any variation of at least one parameter introduces not only a shift in the spectral band in reflection of the variable pitch Bragg grating, but also a modification of its width. The determination of the length of the variable pitch Bragg grating, and therefore of the erosion of the optical fibre, is therefore distorted.

FIGS. 3A, 3B and 3C illustrate the influence of the variation of sensitivity of a variable pitch Bragg grating according to the wavelength. FIG. 3A schematically shows a variable pitch Bragg grating as a set of constant pitch Bragg gratings 31, 32, 33, 34, 35, 36, 37, the various Bragg gratings having pitches that are distinct from each other. FIG. 3B shows the sensitivity of each constant pitch Bragg grating 31-37 to a physical parameter. The abscissa axis represents a temperature variation ΔT, a deformation Δε or a pressure variation ΔP. The ordinate axis represents the Bragg wavelength shift Δλ_{Bragg} of each constant pitch Bragg grating according to the variation of the physical parameter. It can be observed that, for the same variation of a given physical parameter, the Bragg wavelength shift Δλ_{Bragg} is different for the various Bragg gratings. FIG. 3C shows, by two graphs, the spectral response in reflection of each Bragg grating 31-37 for two different physical states. On each graph, the abscissa axis represents the wavelength λ of the radiation reflected by the Bragg gratings 31-37, and the ordinate axis represents the amplitude R of this radiation. A distinct Bragg wavelength shift Δλ_{Bragg} for the various Bragg gratings can also be observed between the two physical states, leading to a first width FWHM₁ of the range of wavelengths reflected by the set of Bragg gratings 31-37 in the first state, and a second width FWHM₂ of the range of wavelengths reflected by the set of Bragg gratings 31-37 in the second state, FWHM₂ being distinct from FWHM₁.

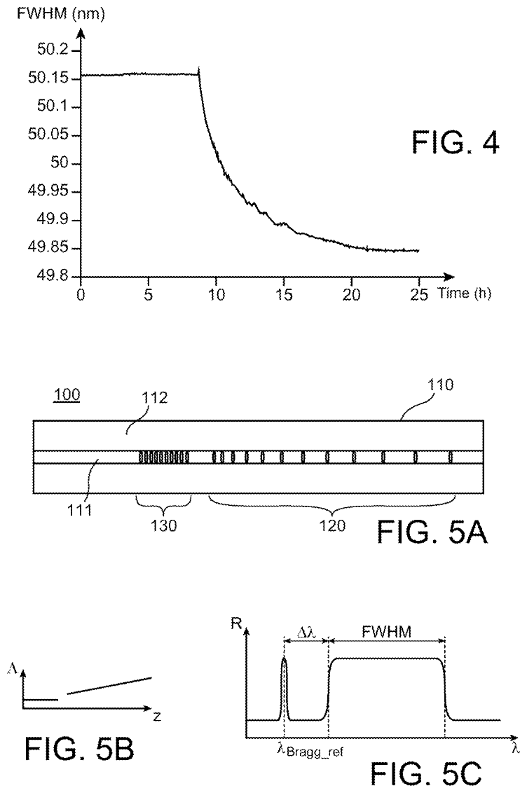

FIG. 4 shows an example of the evolution of the width of the wavelength range of a radiation reflected by a variable pitch Bragg grating during a temperature ramp varying between 750° C. and 20° C. The variable pitch Bragg grating has a physical length of 50 mm (millimetres) and a pitch comprised between 1.052 urn (micrometre) and 1.086 urn. On the graph of FIG. 4, the abscissa axis represents time, in hours, and the ordinate axis represents the width of the spectrum in reflection FWHM, in nanometres. The width FWHM varies between 50.16 nm at a temperature of 750° C. and 49.85 nm at a temperature of 20° C.

FIG. 5A shows a first exemplary embodiment of a Bragg grating erosion sensor according to the invention. The erosion sensor 100 includes an optical fibre 110, a variable pitch Bragg grating 120 and a constant pitch Bragg grating 130. The optical fibre 110 includes a core 111 and an optical sheath 112 surrounding the core 111. The variable pitch Bragg grating 120 and the constant pitch Bragg grating 130 are inscribed in the core 111 of the optical fibre 110. The variable pitch Bragg grating 120 is to be eroded by a distal end of the optical fibre 110, that is to say the end opposite the proximal end connected to a measuring instrument. The variable pitch Bragg grating 120 is therefore also called “measurement Bragg grating” and is inscribed on a measurement section. The constant pitch Bragg grating 130 is intended to provide reference information allowing to correct the measurement error due to the variation of sensitivity of the measurement Bragg grating 120 according to the wavelength. It is therefore also called “reference Bragg grating” and is inscribed on a reference section. The reference Bragg grating 130 is inscribed in the vicinity of the measurement Bragg grating 120. It is therefore subject to the same environment, that is to say the same temperature and hydrostatic pressure variations, the same deformations, and the same ageing effects. In the example of FIG. 5A, the reference section is located upstream of the measurement section, that is to say it is located closer than the measurement section to the proximal end of the optical fibre 110.

FIG. 5B shows the variation of the pitch Λ(z) of the Bragg gratings 120 and 130 along the longitudinal axis of the optical fibre 110. The abscissa axis represents the longitudinal position z of the patterns of each grating and the ordinate axis represents the pitch Λ(z) between two successive patterns at the considered longitudinal position. The pitch of the measurement Bragg grating 120 varies linearly along the longitudinal axis. The pitch of the reference Bragg grating 130 is less than the minimum pitch of the measurement Bragg grating. Thus, the radiation reflected by the reference Bragg grating 130 has a wavelength outside the spectral range of the radiation reflected by the measurement Bragg grating 120 and can be identified.

FIG. 5C shows the spectral response in reflection of the Bragg gratings 120 and 130. The abscissa axis corresponds to the wavelength of the radiation reflected by one of the Bragg gratings 120 and 130, and the ordinate axis corresponds to the amplitude R of the reflected radiation. The measurement Bragg grating 120 is arranged to reflect radiation over a range of wavelengths of width FWHM and the reference Bragg grating is arranged to reflect radiation at a Bragg wavelength λ_{Bragg_ref} Due to the difference in pitch between the Bragg gratings 120 and 130, the Bragg wavelength λ_{Bragg_ref} is located outside the wavelength range of the radiation reflected by the measurement Bragg grating 120. The difference in wavelength between the Bragg wavelength λ_{Bragg_ref} and the lower limit of the spectral range of the radiation reflected by the measurement Bragg grating 120 is denoted Δλ. This wavelength difference is used to correct the measurement error, as indicated below.

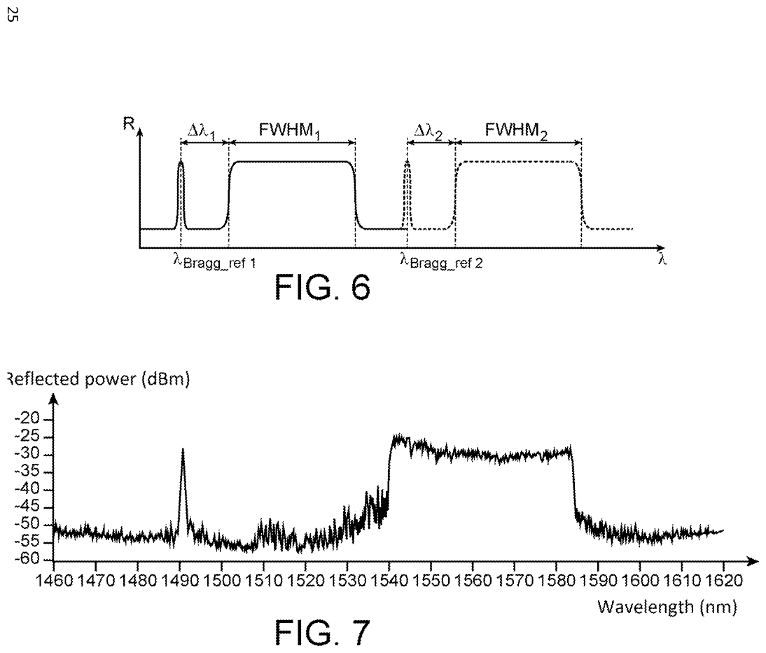

FIG. 6 shows, similarly to FIG. 5C, the spectral response in reflection of the Bragg gratings 120 and 130 for two different physical states. In a first state, the measurement Bragg grating 120 reflects radiation over a range of wavelengths of width FWHM₁ and the reference Bragg grating 130 reflects radiation at a Bragg wavelength λ_{Bragg_ref1}. The wavelength difference between the Bragg wavelength λ_{Bragg_ref1} and the lower limit of the spectral range of the radiation reflected by the measurement Bragg grating 120 is then denoted Δλ₁. In a second state, the measurement Bragg grating 120 reflects radiation over a range of wavelengths of width FWHM₂ and the reference Bragg grating 130 reflects radiation at a Bragg wavelength λ_{Bragg_ref2}. The wavelength difference between the Bragg wavelength λ_{Bragg_ref2} and the lower limit of the spectral range of the radiation reflected by the measurement Bragg grating 120 is then denoted Δλ₂. As a first approximation, it is possible to consider that the sensitivity of a Bragg grating to a physical parameter varies linearly as a function of the Bragg wavelength at which this grating has been inscribed. With such an approximation, the ratio between the width FWHM of the spectrum reflected by the measurement Bragg grating 120 and the wavelength difference Δλ is constant for a given physical length of the measurement Bragg grating 120. Thus, for two physical states, the following relationship holds:

$$\frac{{FWHM}_{1}}{Δ {λ}_{1}} \approx \frac{{FWHM}_{2}}{Δ {λ}_{2}}$$

As a demonstration, consider the case of temperature. Considering a temperature variation ΔT between the temperatures T₁ and T₂, or a reference grating whose Bragg wavelength is λᵣ, and a measurement Bragg grating whose extreme wavelengths are λₘ and λ_{M}. The following quantities Δλ=λₘ−λᵣ and FWHM=λₘ−λₘ are then defined. We note the quantities defined above respectively λᵣ₁, λₘ₁, Δλ₁, FWHM₁ at the temperature T₁ and λᵣ₂, λₘ₂, Δλ₂, FWHM₂ at the temperature T₂. It was seen previously that:

$$\frac{Δ {λ}_{Bragg}}{{λ}_{Bragg}} = ( α + ζ ) Δ T$$

Or else:

$$\frac{Δ {λ}_{Bragg}}{{λ}_{Bragg}} = β Δ T$$

With β=α+ζ the thermal sensitivity. To give an order of magnitude, in the case of a standard germanosilicate fibre, β≈6.32E⁻⁶/° C.
So we have:

$$\frac{d {λ}_{Bragg}}{dT} - β . {λ}_{Bragg} = 0$$

$${λ}_{Bragg} ( T ) = a . {e}^{β T}$$

with a a real constant
for T=T₁: λ_{Bragg}(T₁)=λ₁ that is to say a=λ₁e^{-βT}^{₁}
   λ_{Bragg}(T)=λ₁e^{β(T-T}^{₁}⁾
   that is to say λ₂=λ₁e^{βΔT}
      In real applications we always have βΔT<<1, therefore the expansion limited to the following order 1 can be done:

λ₂=λ₁(1+βΔT)

It is therefore possible to write:

$$Δ {λ}_{2} = {λ}_{m 2} - {λ}_{r 2}$$

$$Δ {λ}_{2} = {λ}_{m 1} ( 1 + β Δ T ) - {λ}_{r 1} ( 1 + β Δ T )$$

$$Δ {λ}_{2} = ( {λ}_{m 1} - {λ}_{r 1} ) ( 1 + β Δ T )$$

$$Δ {λ}_{2} = Δ {λ}_{1} ( 1 + β Δ T )$$

$$\frac{Δ {λ}_{2}}{Δ {λ}_{1}} = ( 1 + β Δ T )$$

### Similarly:

$${FWHM}_{2} = {λ}_{M 2} - {λ}_{m 2}$$

$${FWHM}_{2} = {λ}_{M 1} ( 1 + β Δ T ) - {λ}_{m 1} ( 1 + β Δ T )$$

$${FWHM}_{2} = ( {λ}_{M 1} - {λ}_{m 1} ) ( 1 + β Δ T )$$

$${FWHM}_{2} = {FWHM}_{1} ( 1 + β Δ T )$$

$$\frac{{FWHM}_{2}}{{FWHM}_{1}} = ( 1 + βΔ T )$$

### That is to say in the end:

$$\frac{Δ {λ}_{2}}{Δ {λ}_{1}} = \frac{{FWHM}_{2}}{{FWHM}_{1}}$$

Or else:

$$∀ Δ T , \frac{{FWHM}_{1}}{Δ {λ}_{1}} = \frac{{FWHM}_{2}}{Δ {λ}_{2}} = C , C ∈ ℝ$$

This constant ratio can then be used as a correction coefficient for the measurement of the physical length of the measurement Bragg grating. Now consider two states of erosions 3 and 4, at constant temperature, with a Bragg grating of length L. Note respectively the previously defined quantities L₃, Δλ₃ and FWHM₃ at state 3 and L₄, Δλ₄ and FWHM₄ at state 4. Considering a variable pitch Bragg grating inscribed according to a proportionality relationship between its length and its width at mid-height, it is possible to write:

L=a FWHM,aϵ

[symbol]

Δλ₃=Δλ₄

### That is to say:

$$\frac{{L}_{4}}{{L}_{3}} = \frac{{FWHM}_{4} / {Δλ}_{4}}{{FWHM}_{3} / {Δλ}_{3}}$$

Or else:

$${L}_{4} = \frac{{FWHM}_{4}}{Δ {λ}_{4}} \frac{{L}_{3}}{{FWHM}_{3} / {Δλ}_{3}}$$

By considering state 3 as the initial state of the grating at the time of its inscription, there is a direct proportionality relationship between, on the one hand, the length of the measurement Bragg grating and, on the other hand, the ratio between its width at mid-height and its difference from the reference grating regardless of the temperature.

$$∀ T , L ∝ \frac{FWHM}{Δ λ}$$

Of course, it is possible to more finely correct the measurement of the physical length of the measurement Bragg grating 120 by taking into account the non-linearity of the sensitivity of a Bragg grating according to the wavelength.

The inventors have produced a Bragg grating erosion sensor in accordance with the invention. A variable pitch Bragg grating and a constant pitch Bragg grating were inscribed in the core of an optical fibre by femtosecond laser. The variable pitch Bragg grating has a physical length of 50 mm in length and a pitch varying between 1 μm and 1.1 μm, giving a spectral width of 44 nm at room temperature. The constant pitch Bragg grating has a length of 2 mm and is positioned 1 mm upstream of the variable pitch Bragg grating. FIG. 7 shows, by a graph, the spectral response in reflection of this erosion sensor. In this graph, the abscissa axis represents the wavelength of the radiation reflected by the Bragg gratings, in nanometres, and the ordinate axis represents the power of the reflected radiation, in dBm.

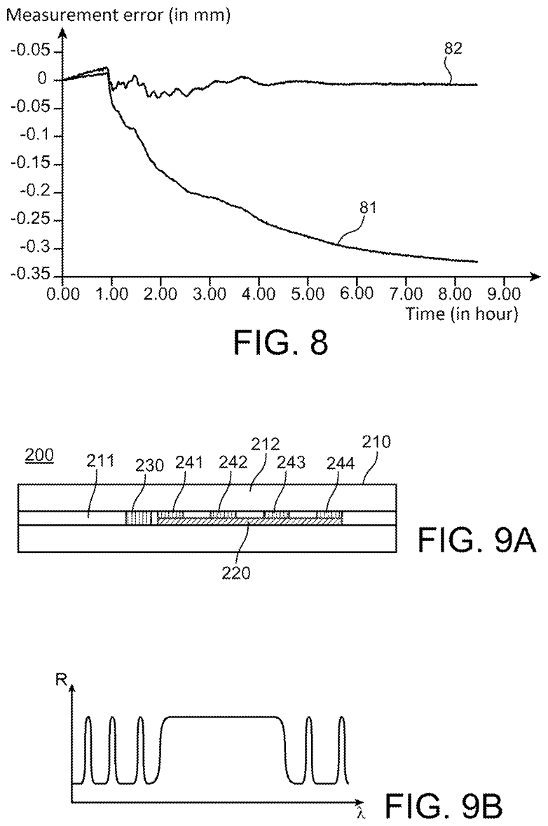

In order to test the effect of the compensation of the variation of sensitivity on the measurement of the physical length of the measurement Bragg grating, the optical fibre was subjected to a temperature ramp varying from 750° C. to room temperature. The width at mid-height FWHM of the spectrum reflected by the measurement Bragg grating and the wavelength difference Δλ were measured during the temperature drop of the optical fibre. The physical length of the measurement Bragg grating was then determined, on the one hand, according to the width FWHM and, on the other hand, according to the same width FWHM and the wavelength difference Δλ. FIG. 8 shows, by a graph, the error on the determination of the physical length of the measurement Bragg grating. The abscissa axis represents time, in hours, and the ordinate axis represents the length error, in millimetres. A first curve 81 corresponds to the length error determined without compensation for the variation of sensitivity and a second curve 82 corresponds to the error in length determined with compensation for the variation of sensitivity. It can be observed that, without compensation, the maximum length error is 330 μm at room temperature. With compensation, the maximum length error is 30 μm. The error in determining the physical length of the Bragg grating is thus reduced by a factor of 11.

FIG. 9A schematically shows a second exemplary embodiment of a Bragg grating erosion sensor according to the invention. The erosion sensor 200 includes an optical fibre 210, a variable pitch Bragg grating 220, a first constant pitch Bragg grating 230 and four second constant pitch Bragg gratings 241, 242, 243 and 244. The optical fibre 210 includes a core 211 and an optical sheath 212 surrounding the core 211. The variable pitch Bragg grating 220, also called “measurement Bragg grating”, is inscribed in the core 211 of the optical fibre 210 over a measurement section. The first constant pitch Bragg grating 230, also called “first reference Bragg grating”, is inscribed in the core 211 on a first reference section, upstream of the measurement section. The second constant pitch Bragg gratings 241, 242, 243, 244, also called “second reference Bragg gratings”, are inscribed in the core 211 on second reference sections distributed along the measurement section. The measurement Bragg grating 220 and the second reference Bragg gratings 241, 242, 243, 244 are point-to-point gratings. The reference Bragg gratings 230, 241, 242, 243, 244 have pitches that are distinct from each other so as to reflect radiation at differentiable Bragg wavelengths. Since the reference Bragg gratings 230, 241, 242, 243, 244 are inscribed in the same core as the measurement Bragg grating 220, they must also have a pitch different from the pitch range of the measurement Bragg gating 220.

FIG. 9B shows the spectral response in reflection of the Bragg gratings 220, 230, 241, 242, 243 and 244. The abscissa axis corresponds to the wavelength λ of the radiation reflected by one of the Bragg gratings, and the ordinate axis corresponds to the amplitude R of the reflected radiation. The Bragg wavelengths of the various constant pitch Bragg gratings are distinct from each other and located outside the wavelength range of the radiation reflected by the measurement Bragg grating 220. The reference Bragg gratings and, in particular, the second reference Bragg gratings 241, 242, 243, 244, allow to measure a variation of a physical parameter along the measurement section and thus to refine the estimate of the physical length of the measurement Bragg grating 220.

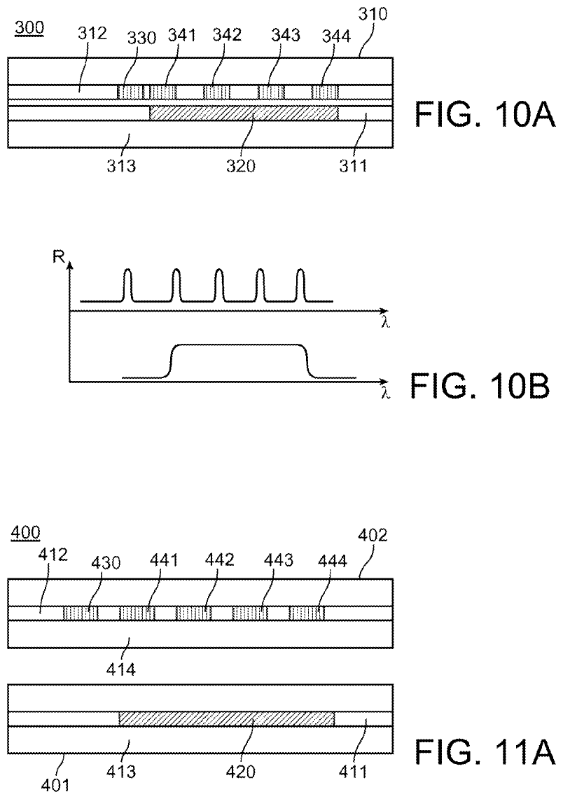

FIG. 10A schematically shows a third exemplary embodiment of a Bragg grating erosion sensor according to the invention using a multicore optical fibre. The erosion sensor 300 includes an optical fibre 310, a variable pitch Bragg grating 320, a first constant pitch Bragg grating 330 and four second constant pitch Bragg gratings 341, 342, 343 and 344. The optical fibre 310 includes a first core 311, called “measurement core”, a second core 312 called “reference core”, and an optical sheath 313 surrounding the two cores 311, 312. The measurement Bragg grating 320 is inscribed in the measurement core 311 over a measurement section. The first reference Bragg grating 330 is inscribed in the reference core 312 on a first reference section, upstream of the measurement section. The second reference Bragg gratings 341, 342, 343, 344 are inscribed in the reference core 312 on second reference sections distributed along the measurement section. The reference Bragg gratings 330, 341, 342, 343, 344 have pitches that are distinct from each other so as to reflect radiation at differentiable Bragg wavelengths. On the other hand, the second reference Bragg gratings 341, 342, 343, 344 each have a pitch equal to or close to the local pitch of the measurement Bragg grating 320. In other words, each second reference Bragg grating has a pitch equal to or close to the average pitch of the measurement Bragg grating 320 on the second reference section considered.

FIG. 10B shows the spectral response in reflection of the Bragg gratings 320, 330, 341, 342, 343 and 344. The Bragg wavelengths of the various constant pitch Bragg gratings are distinct from each other. The Bragg wavelengths of the second reference Bragg gratings 341, 342, 343 and 344 are however located in the wavelength range of the radiation reflected by the measurement Bragg grating 320. Thus, the variation of sensitivity of the Bragg grating with the wavelength can be finely estimated.

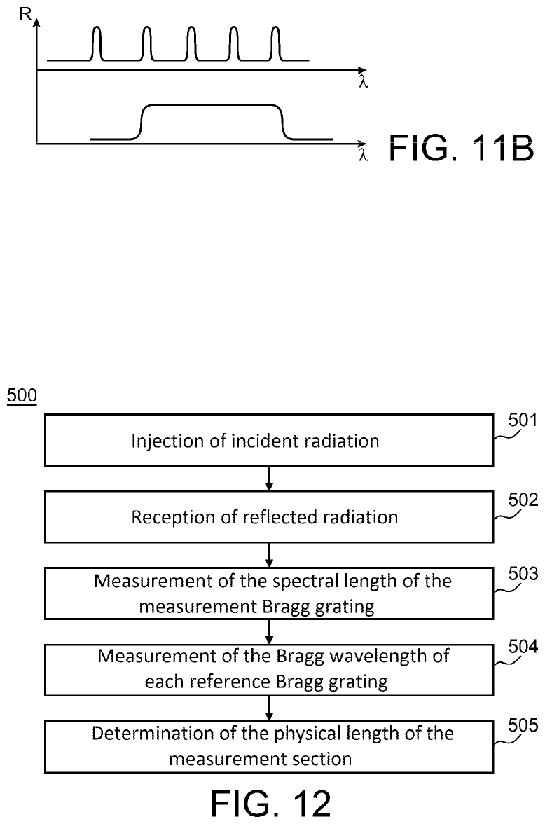

FIG. 11A schematically shows a fourth exemplary embodiment of a Bragg grating erosion sensor according to the invention using two single-core optical fibres. The erosion sensor 400 includes a first optical fibre 401, a second optical fibre 402, a variable pitch Bragg grating 420, a first constant pitch Bragg grating 430 and four second constant pitch Bragg gratings 441, 442, 443 and 444. The optical fibre 401 includes a core 411 and an optical sheath 413 surrounding the core 411. The optical fibre 402 includes a core 412 and an optical sheath 414 surrounding the core 412. The measurement Bragg grating 420 is inscribed in the core 411 of the optical fibre 401 over a measurement section. The first reference Bragg grating 430 is inscribed in the core 412 of the second optical fibre 402 on a first reference section, upstream of the measurement section. The second reference Bragg gratings 441, 442, 443, 444 are inscribed in the core 412 of the second optical fibre 402 on second reference sections distributed along the measurement section. Identically to the third exemplary embodiment, the reference Bragg gratings 430, 441, 442, 443, 444 have pitches that are distinct from each other so as to reflect radiation at Bragg wavelengths that can be differentiated. The second reference Bragg gratings 441, 442, 443, 444 each have a pitch equal to or close to the local pitch of the measurement Bragg grating 420. Preferably, the two optical fibres 401, 402 are mechanically connected to each other, so that the reference Bragg gratings 430, 441, 442, 443, 444 undergo the same deformations as the measurement Bragg grating 420.

FIG. 11B shows the spectral response in reflection of the Bragg gratings 420, 430, 441, 442, 443 and 444. This spectral response is identical to that of the third exemplary embodiment.

Other exemplary embodiments may be considered within the scope of the invention. In particular, the erosion sensor may include only reference Bragg gratings inscribed on the measurement section. In other words, the erosion sensor may not include a first reference Bragg grating inscribed on a section upstream of the measurement section. Moreover, the erosion sensor may include any number of reference Bragg gratings. The number of these gratings may in particular vary according to the physical length of the measurement Bragg grating and/or the desired measurement accuracy.

FIG. 12 shows an example of a method for determining the physical length of a measurement Bragg grating in an erosion sensor according to the invention. The method 500 comprises a first step 501 wherein incident radiation is injected into the core of each optical fibre wherein a Bragg grating is inscribed. The incident radiation must have a wavelength range spanning the wavelength range of the measurement Bragg grating and the wavelength range of each of the reference Bragg gratings. In a second step 502, the radiation reflected by the various Bragg gratings is received by a processing unit. In a step 503, the spectral width of the radiation reflected by the measurement Bragg grating is measured. The spectral width is for example the width at mid-height of the maximum of the peak (FWHM). The Bragg wavelength of each reference Bragg grating is measured in a step 504. It should be noted that steps 503 and 504 can be carried out simultaneously or consecutively, in any order. In a fifth step 505, the physical length of the measurement section is determined according to the spectral width of the radiation reflected by the measurement Bragg grating and the Bragg wavelength of each reference Bragg grating. In particular, when the erosion sensor includes a single reference Bragg grating, the physical length of the measurement section can be determined according to the spectral width of the radiation reflected by the measurement Bragg grating and the wavelength difference between the Bragg wavelength of the reference Bragg grating and a lower or upper limit of the wavelength range of the radiation reflected by the measurement Bragg grating.

1. A Bragg grating erosion sensor comprising:
one or more optical fibres, each optical fibre comprising one or more cores and an optical sheath surrounding the one or more cores,
a variable pitch measurement Bragg grating inscribed in one of the cores of one of the optical fibres over a measurement section to be eroded, and
one or more reference Bragg gratings, each reference Bragg grating being inscribed in one of the cores of one of the optical fibres.

2. The erosion sensor according to claim 1, wherein at least one of the one or more reference Bragg gratings, is a constant pitch Bragg grating.

3. The erosion sensor according to claim 1, wherein the measurement Bragg grating and at least one of the one or more reference Bragg gratings are inscribed in a same core of an optical fibre.

4. The erosion sensor according to claim 1, wherein at least one Bragg grating is formed by a set of bubbles.

5. The erosion sensor according to claim 1, wherein one of the one or more optical fibres comprises a measurement core and a reference core, the measurement Bragg grating being inscribed in the measurement core and at least one of the one or more reference Bragg gratings being inscribed in the reference core.

6. The erosion sensor according to claim 5, wherein each reference Bragg grating inscribed in the reference core is arranged to reflect radiation in a wavelength range comprised in a range of wavelengths reflected by the measurement Bragg grating.

7. The erosion sensor according to claim 1, wherein the measurement section extends between a proximal end, arranged to receive incident radiation, and a distal end, arranged to be eroded, the one or more reference Bragg gratings comprising a first reference Bragg grating inscribed on a first reference section located in a vicinity of the proximal end.

8. The erosion sensor according to claim 7, wherein the first reference section is located upstream of the measurement section.

9. The erosion sensor according to claim 7, wherein the first reference section is included in the measurement section.

10. The erosion sensor according to claim 1, wherein the one or more reference Bragg gratings comprise a plurality of second reference Bragg gratings distributed along the measurement section.

11. The erosion sensor according to claim 10, wherein one of the one or more optical fibres comprises a measurement core and a reference core, the measurement Bragg grating being inscribed in the measurement core and the second reference Bragg gratings being inscribed in the reference core, each second reference Bragg grating having a pitch equal to a local pitch of the measurement Bragg grating.

12. The erosion sensor according to claim 11 further comprising a processing unit configured to measure a spectral width of radiation reflected by the measurement Bragg grating, to measure a wavelength of radiation reflected by at least one reference Bragg grating, and determine a physical length of the measurement section according to the spectral width of the radiation reflected by the measurement Bragg grating and the wavelength of the radiation reflected by the at least one reference Bragg grating.

13. The erosion sensor according to claim 12, wherein the processing unit is configured to determine the physical length of the measurement section according to the spectral width of the radiation reflected by the measurement Bragg grating and to a wavelength difference between a wavelength of the radiation reflected by the measurement Bragg grating and the wavelength of the radiation reflected by the at least one reference Bragg grating.

14. The erosion sensor according to claim 12, wherein the processing unit is configured to measure a wavelength of the radiation reflected by each of the second reference Bragg gratings, to determine a variation of a physical parameter along the measurement section according to the wavelengths of the radiation reflected by the second reference Bragg gratings, and to determine the physical length of the measurement section according to the spectral width of the radiation reflected by the measurement Bragg grating and the variation of the physical parameter along the measurement section.

15. A method for determining a physical length of the measurement section of the erosion sensor according to claim 1, comprising the steps of:
measuring a spectral width of radiation reflected by the measurement Bragg grating,
measuring a wavelength of radiation reflected by at least one of the one of more reference Bragg gratings, and
determining the physical length of the measurement section according to the spectral width of the radiation reflected by the measurement Bragg grating and the wavelength of the radiation reflected by the at least one reference Bragg grating.
